(19) United States
(12) Patent Application Publication
(10) Pub. No.: US 2006/0178250 A1
(43) Pub. Date: Aug. 10, 2006

(54) Grocery bag handle

(76) Inventor: Michael Findon, Palm Bay, FL (US)

Correspondence Address: LINDON & LINDON, 1250 LINDA STREET, ROCKY RIVER, OH, 44116, US

(21) Appl. No.: 11/339,376

(22) Filed: Jan. 26, 2006

Related U.S. Application Data
(60) Provisional application No. 60/649,531, filed on Feb. 4, 2005.

(51) Int. Cl. B31B 1/64

(52) U.S. Cl. 493/221; 493/194

(57) ABSTRACT

A device for supporting a package. The device includes a handle portion with an opening in the handle portion to receive one or more portions of the package. The device includes a bearing portion operatively connected to the handle portion and having an apex adapted to support one or more portions of the package.

### BACKGROUND OF INVENTION

Grocery bags and other bags can be hard to organize and carry, especially by hand. For economic and environmental reasons, thin plastic bags have become popular for use in grocery markets and the like. These plastic bags are often rather cumbersome and unruly to handle manually. There is a long-felt need for a suitable way to organize and carry such bags and other bags and packages.

### BRIEF DESCRIPTION OF THE DRAWINGS

FIG. 1 is an elevational view of a bag handle according to the present invention.

FIG. 2 is an elevational view of the bag handle of FIG. 1 supporting a prior art bag.

FIG. 3 is an elevational view of an alternate embodiment of the present invention with a strap.

FIG. 4 is an elevational front view of a bag handle according to the present invention.

FIG. 4a is elevational side view of the bag handle of FIG. 4.

FIG. 5 is an elevational view of a bag handle according to the present invention.

FIG. 6 is an elevational side view of the bag handle of FIG. 5.

FIG. 7 is an elevational view of a bag handle according to the present invention with a strap and a bag.

FIG. 8 is an elevational view of a strap and holder used with the bag handle of FIG. 7.

FIGS. 9-12 are a series of views showing the bag handle according to the present invention being coupled with a plurality of grocery bags.

FIG. 13 is a view of the bag handle embodying the present invention being used in a relatively “hands free” mode with a strap around the user's neck being operatively connected to the bag handle.

### BRIEF SUMMARY OF INVENTION

A device for supporting a package. The device includes a handle portion with an opening in the handle portion to receive one or more portions of the package. The device includes a bearing portion operatively connected to the handle portion and having an apex adapted to support one or more portions of the package.

A device for supporting a package. The device includes a handle portion having an opening there through and generally aligned along a first axis, the first axis being positioned through a central portion of the handle portion. The device includes a bearing portion having a first leg generally aligned along a second axis being positioned through a central portion of the first leg. The bearing portion has a second leg generally aligned along a third axis being positioned through a central portion of the second leg. The first axis intersects with the second axis and the third axis.

A device for organizing a plurality of packages. The device includes a handle portion with an opening in the handle portion to receive the plurality of packages. The device includes a bearing portion operatively connected to the handle portion and having a first leg and second leg which intersect each other to define an apex adapted to support one or more portions of the package.

### DETAILED DESCRIPTION OF THE PREFERRED EMBODIMENTS

This application claims the benefit of U.S. Provisional Application No. 60/649,531, filed Feb. 4, 2005.

Referring to the figures, there is shown a bag handle, indicated generally at 20, according to the present invention. The bag handle 20 includes a handle portion 24 and a bearing portion 28. The handle portion 24 and the bearing portion 28 may be integrally formed, as shown, or may be secured together in any suitable fashion. The title “bag handle” is not a limitation on the use of the invention.

The illustrated handle portion 24 of the bag handle 20 includes an opening 32 therein. The opening 32 may be any suitable size and profile as desired. The opening 32 may be located at any suitable location on the bag handle 20 and is not necessarily restricted to the handle portion 24 in general or the central region of the handle portion 24 in particular.

The handle portion 24 may include an inner surface 36 and an outer surface 40. The illustrated inner surface 32 defines a grip 44. The illustrated grip 44 includes a first indentation 48, a second indentation 52, a third indentation 56, and a fourth indentation 58. Numerical terms, such as for example “first”, and “second,” are not intended as a limitation or to imply a sequence, unless otherwise specified or made apparent by the context of the discussion. The illustrated opening 32 in the bag handle 20 is positioned between the second indentation 52 and the third indentation 56, of the grip 44 of the handle portion 24 of the bag handle 20. The first indentation 48 and the fourth indentation 58 are shown generally at terminal portions of the handle portion 24.

The bearing portion 28 of the bag handle 20 may define any suitable angle(s). The term “bearing” as used in this application may be understood to include, but is not limited to, any structure or functionality which supports the weight of something. The outer surface 40 of the bearing portion 28 forms an outer tip portion 60. The inner surface 36 of the bearing portion 28 forms an inner tip portion 64. The outer tip portion 60 and the inner tip portion 64 define a tip portion 68 of the bearing portion 28 of the bag handle 20. The inner tip portion 64, first indentation 48 and the fourth indentation 58 may define three acute angles, or any other angles or combination or angles, on the inner surface of the bag handle 20.

The angle B1 defined by the first indentation 48 at the intersection of the handle portion 24 and the first leg 70 is shown as an acute angle of about forty five (45) degrees. The angle B3 defined by the fourth indentation 58 at the intersection of the handle portion 24 and the second leg 72 is shown as an acute angle of about forty five (45) degrees. The angle B2 defined by the inner tip portion 64 at the intersection of the first leg 70 and the second leg 72 is shown as an angle of about ninety (90) degrees. It will be appreciated that a wide variety of angles may be employed and varied as desired. The bag handle 20 may be made more compact—and the overall geometrical profile of the bag handle 20 may be altered as desired without departing from the scope of the invention.

The tip portion 68 may define an apex as shown. The term “apex” as used in this application may be understood to include, but is not limited to, any structure or functionality which generally defines or includes a tip, point, peak, or terminus. The “apex” may be provided at any suitable location at any suitable orientation of the bag handle 20. It will be noted that the closer the tip portion 68 is position to the handle portion 24 of a given length, the greater the angle that will be observed at the inner tip portion 64 of the bearing portion 28 of the bag handle 20.

The term “angle” as used in this application may be understood to include, but is not limited to, any structure or functionality which generally defines or creates a corner. The corner may constitute a projecting part or an enclosed or partially enclosed space. The corner may be generally straight, generally curved or arced—or partially straight or curved. The term “angle” may also include the space between two lines or surfaces at or near the point at which they touch and/or intersect.

The bag handle 20 includes a first leg 70 and a second leg 72. The term “leg” as used in this application may be understood to include, but is not limited to, any structure or functionality which generally defines or includes a branch or part of an object or system. The illustrated first leg 70 and the second leg 72 intersect at the tip portion 68 of the bearing portion 28 of the bag handle 20. It will be noted that the first leg 70 and the second leg 72 intersect to define a generally “V” shaped member. The term “intersect” as used in this application may be understood to include, but is not limited to, any structures or functionalities which generally pass, lie across, cross, and/or cut into each other. The illustrated first leg 70 and the second leg 72, or any portion thereof, may be generally straight or generally curved.

It will be noted that the handle portion 24 of the bag handle 20 may be generally aligned along a first axis A1. The term “axis” as used in this application may be understood to include, but is not limited to, a generally straight line about which a body or a geometric figure rotates or may be supposed to rotate. The “axis” may be a generally straight line with respect to which a body, component, or figure may be generally symmetrical. The “axis” may be a reference line of a coordinate system. The first leg 70 may be generally aligned along a second axis A2. The second leg 72 may be generally aligned along a third axis A3.

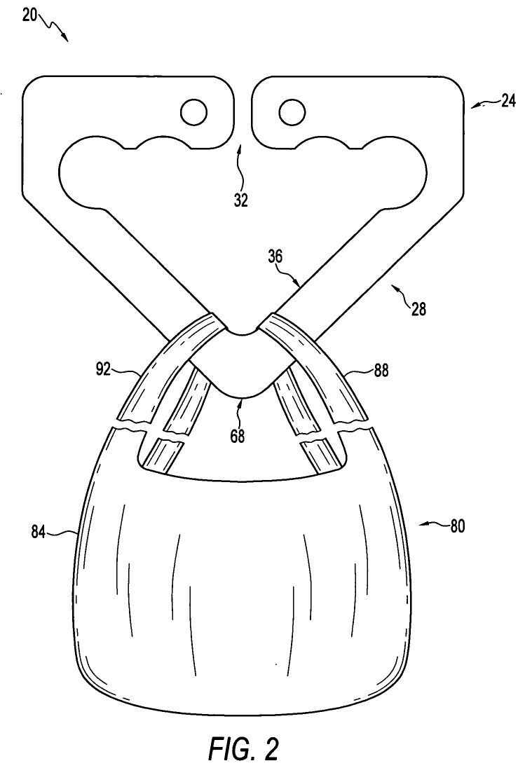

Referring also to FIG. 2, the bag handle 20 is shown supporting a bag, indicated generally at 80. The relative sizes of the bag handle 20 and the bag 80 are shown for purposes of clarity and to facilitate description. The illustrated bag 80 is a prior art grocery bag which includes a sack portion 84, a first handle loop 88 and a second handle loop 92. The sack portion 84 might support a load, such as for example groceries. The first handle loop 88 and the second handle loop 92 are shown in contact with the inner surface 36 of the bearing portion 28 of the bag handle 20. The first handle loop 88 and the second handle loop 92 are shown in contact with the tip portion 68 of the bearing portion 28 of the bag handle 20.

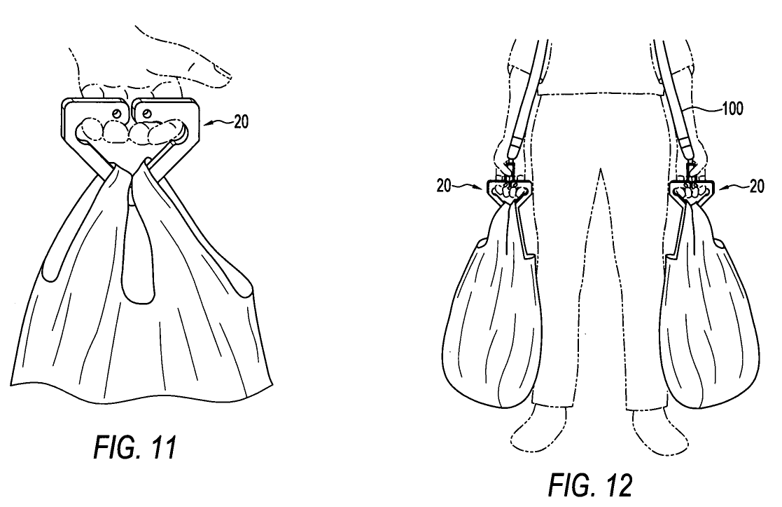

Referring also to FIG. 2, it will be appreciated that the first handle loop 88 and the second handle loop 92 were fed through the opening 32 in the handle portion 24 of the bag handle 20 before coming into contact with the tip portion 68 of the bearing portion 28 of the bag handle 20. The term “fed” as used here is understood to include any suitable means of channeling or directing. The bag handle 20 may be adapted to accommodate a plurality of bags or other suitable containers that may be generally closed and/or used for holding, storing, or carrying something. It will be appreciated that, without the bag handle 20, the user (shown in FIGS. 11-13) might normally carry the bag 80 by grasping the first handle loop 88 and the second handle loop 92 of the bag 80. Likewise, the user (shown in FIGS. 11-13) would normally carry a plurality of bags in a similar yet more cumbersome fashion.

Handling, using, and positioning of the bag handle 20 may be accomplished in any suitable fashion. One such way of doing so is for a user to place and/or use his/her hand with an “index finger” into the first indentation 48, a “middle finger” (or the generally longest finger) into the second indentation 52, a “ring finger” into the third indentation 56, and a “pinky finger” into the fourth indentation 58. The user can also grasp other suitable portions of the handle portion 24 of the bag handle 20 in the palm of the user's hand. When the bag 80 is positioned as shown in FIG. 2, the user can easily lift, carry, store, and retrieve the bag 80 with the bag handle 20.

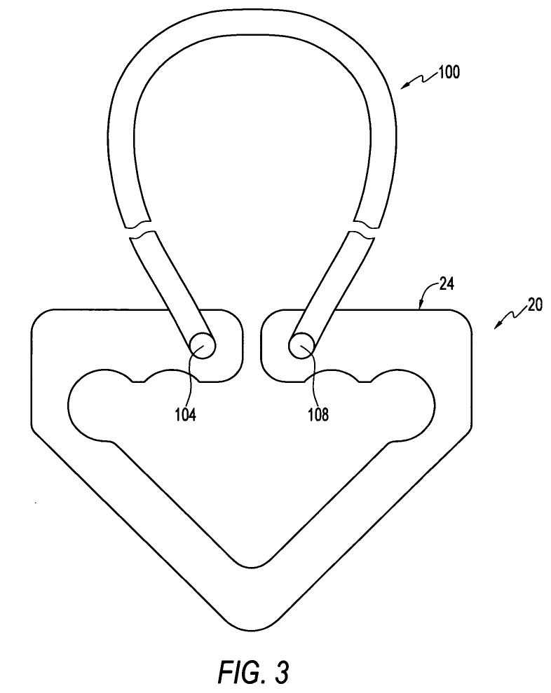

Referring also to FIG. 3, an alternate embodiment of the invention is shown. The bag handle 20 is shown in conjunction with a strap 100. The term “strap” is understood to include a strip or thong of a flexible material used for securing, holding together, or wrapping. The strap 100 is shown secured to the handle portion 24 of the bag handle 20. A first attachment point 104 and a second attachment point 108 are provided to secure the strap 100 and the handle portion 24 of the bag handle 20 together.

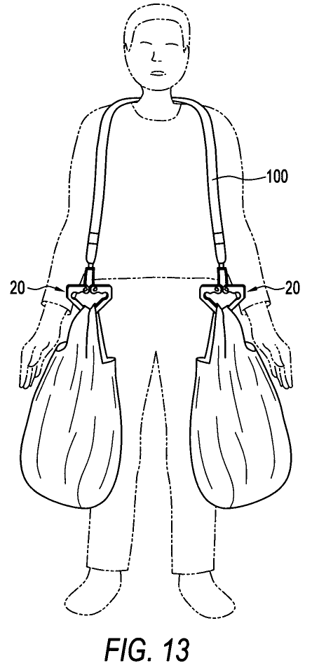

The embodiment of the invention shown in FIGS. 3 and 13 are comparatively “hands free” embodiments since the user can position the strap 100 around the user's neck, over a shoulder, across a back, or the like. This allows the user to employ the invention while still being able to disengage one or both hands from the handle portion 24 of the bag handle 20.

It will be appreciated that while the bag handle 20 is being used with one or more bags, the bags may be set down by the user, such as for example into the trunk of an automobile, and the bag handle 20 remain substantially engaged with the bags. For example, this allows the user to have groceries carried in bags to the automobile with the bag handle 20, place the bags into the automobile, drive to a desired destination, and remove the bags from the automobile with the bag handle 20 still generally engaged with the bags.

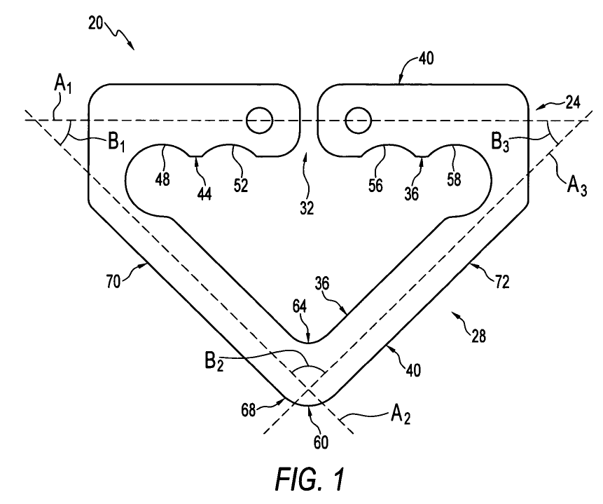

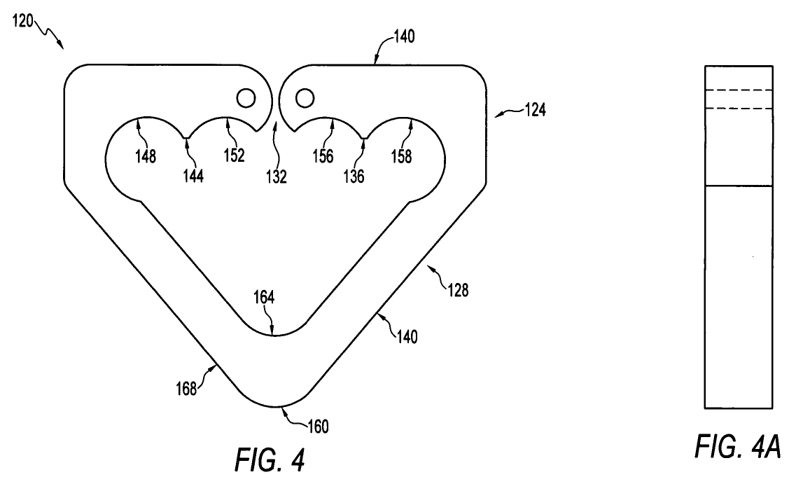

Referring now to FIG. 4, the illustrated handle portion 124 of the bag handle 120 includes an opening 132 therein. It will be noted that the opening 132 in FIG. 4 is has a relatively generally rounded profile compared to the relatively generally squared opening 32 shown in FIG. 1. The relatively generally rounded profile of the opening 132 may facilitate the placement or loading of bags through the opening 132.

The handle portion 124 includes an inner surface 136 and an outer surface 140. The inner surface 132 defines a grip 144. The illustrated grip 144 includes a first indentation 148, a second indentation 152, a third indentation 156, and a fourth indentation 158. The opening 132 in the bag handle 120 is positioned between the second indentation 152 and the third indentation 156, of the grip 144 of the handle portion 124 of the bag handle 120. The first indentation 148 and the fourth indentation 158 are shown generally at a terminal portion of the handle portion 124.

The outer surface 140 of the bearing portion 128 forms an outer tip portion 160. The inner surface 136 of the bearing portion 128 forms an inner tip portion 164. The outer tip portion 160 and the inner tip portion 164 define a tip portion 168 of the bearing portion 128 of the bag handle 120. The inner tip portion 164, first indentation 148 and the fourth indentation 158 define three angles on the inner surface of the bag handle 120.

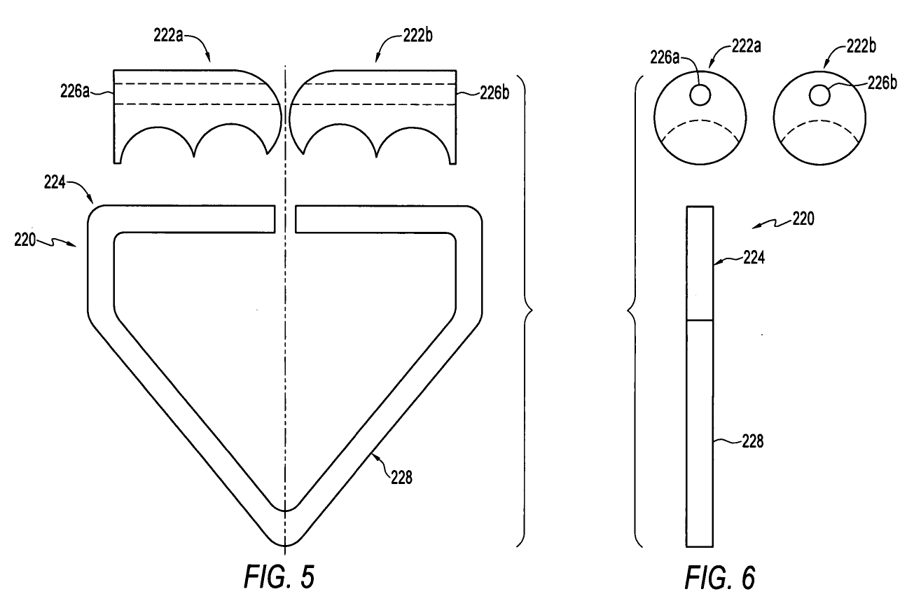

Referring now to FIG. 5 and FIG. 6, the illustrated bag handle 220 may be coupled with a couple of jackets 222a, 222b. The jackets 222a, 222b may be detachable coverings. The jackets 222a, 222b may be sheaths. The jackets 222a, 222b may each include an opening 226a, 226b there through. The illustrated bag handle 220 includes a handle portion 224 and a bearing portion 228. The handle portion 224 of the bag handle 220 may be threaded or connected with the jackets 222a, 222b via the openings 226a, 226b. It will be noted that the jackets 222a, 222b include similar indentations and functionality as the handle portion 24 of the bag handle 20 of FIG. 1.

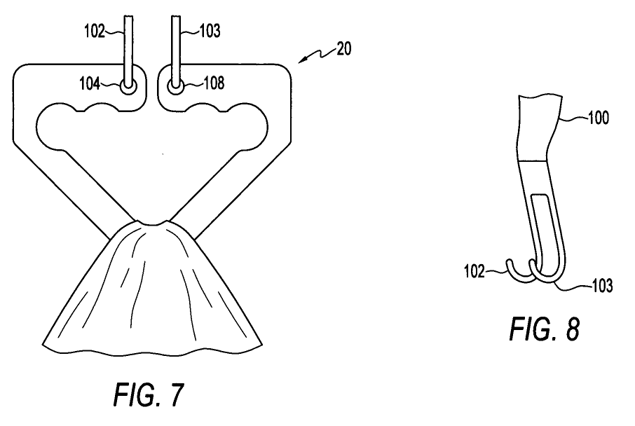

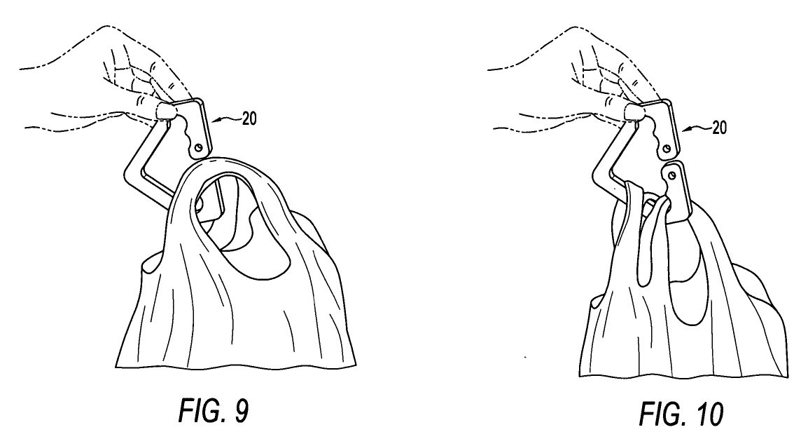

More detail for the generally hands free aspect of the invention can be seen in FIGS. 7 and 8. Similar to the bag handle 20 shown in FIG. 3, the bag handle 20 shown in FIG. 7 includes the first attachment point 104 and the second attachment point 108. The illustrated first attachment point 104 and the second attachment point 108 may be holes or any suitable opening. The strap 100 may be coupled with a first hook 102 and a second hook 103. The first hook 102 and the second hook 103 are positioned in the first attachment point 104 and the second attachment point 108 respectively.

In operation, the invention is not limited to use with a bag. For example, the invention may be employed for picking up a package in a manner similar to the bag. The package may be wrapped with one or more ties or cords—such as for example a wrapped bundle of newspapers. The package tie or cord could be positioned through the opening in the invention handle, allowing for the tie or cord to be supported by the bearing portion of the handle. In operation, the invention provides for a useful means of organizing and carrying packages. The term “packages” is not limited to bags, but may include bags. For purposes of clarity, the invention may be illustrated in conjunction with one or more bags, but is not so limited. For example, the invention may be employed to facilitate handling paint cans, paint buckets, and the like.

The invention may be made from any suitable material and by any suitable method. The invention may be adapted to fit a wide variety of uses. It will be appreciated that the components of the invention may be easily modified as needed to accommodate varying sizes and shapes.

It is to be understood that the invention is not limited in its application to the details of construction and to the arrangements of the components set forth in the accompanying description or illustrated in the drawings. The invention is capable of other embodiments and of being practiced and carried out in various ways. Also, it is to be understood that the phraseology and terminology employed herein are for the purpose of description and should not be regarded as limiting. The disclosure may readily be utilized as a basis for the designing of other structures, methods and systems for carrying out the present invention. It is important, therefore, that the claims be regarded as including equivalent constructions. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract and disclosure are neither intended to define the invention of the application, which is measured by the claims, nor are they intended to be limiting as to the scope of the invention in any way.

What is claimed is:

1. A device for supporting a package comprising:
a handle portion with an opening in the handle portion to receive one or more portions of the package; and
a bearing portion operatively connected to the handle portion and having an apex adapted to support one or more portions of the package.

2. The device of claim 1 wherein the apex defines an obtuse angle.

3. The device of claim 1 wherein the apex defines an acute angle.

4. The device of claim 1 wherein the apex defines a right angle.

5. The device of claim 1 wherein the bearing portion includes two legs which intersect each other.

6. The device of claim 5 wherein the bearing portion includes two legs which intersect to define a generally “V” shaped member.

7. The device of claim 5 wherein the two legs are generally straight.

8. The device of claim 5 wherein the two legs intersect to define a generally rounded point of intersection.

9. The device of claim 1 wherein the handle portion includes an indentation adapted to receive a human finger.

10. The device of claim 1 wherein the handle portion includes an opening adapted to support a strap.

11. A device for supporting a package comprising:
a handle portion having an opening there through and generally aligned along a first axis, the first axis being positioned through a central portion of the handle portion;
a bearing portion having a first leg generally aligned along a second axis being positioned through a central portion of the first leg, and the bearing portion having a second leg generally aligned along a third axis being positioned through a central portion of the second leg;
wherein the first axis intersects with the second axis and the third axis.

12. The device of claim 11 wherein the first leg and the second leg define an apex.

13. The device of claim 11 wherein the first leg and the second leg define a generally “V” shaped member.

14. The device of claim 11 further comprising a strap operatively connected to the handle portion.

15. The device of claim 11 wherein the handle portion includes an indentation adapted to receive a human finger.

16. The device of claim 11 wherein second axis and the third axis define an obtuse angle.

17. A device for organizing a plurality of packages comprising:
a handle portion with an opening in the handle portion to receive the plurality of packages; and
a bearing portion operatively connected to the handle portion and having a first leg and second leg which intersect each other to define an apex adapted to support one or more portions of the package.

18. The device of claim 17 wherein the handle portion is generally aligned along a first axis, the first axis being positioned through a central portion of the handle portion, and the first leg is generally aligned along a second axis being positioned through a central portion of the first leg, wherein the first axis and the second axis intersect and the handle portion and the first leg intersect.

19. The device of claim 17 wherein the second axis and the third axis define an obtuse angle.

20. The device of claim 17 wherein the handle portion includes an indentation adapted to receive a human finger.
